(19) United States
(12) Patent Application Publication
(10) Pub. No.: US 2015/0120374 A1
(43) Pub. Date: Apr. 30, 2015

(54) AUTOMATION OF CUSTOMER RELATIONSHIP MANAGEMENT (CRM) TASKS RESPONSIVE TO ELECTRONIC COMMUNICATIONS

(71) Applicant: SugarCRM Inc., Cupertino, CA (US)

(72) Inventors: Dmitriy Kolegayev, West Hollywood, CA (US); Shaji Sarangadharan, Basking Ridge, NJ (US)

(73) Assignee: SugarCRM Inc., Cupertino, CA (US)

(21) Appl. No.: 14/066,808

(22) Filed: Oct. 30, 2013

(51) Int. Cl. G06Q 10/06

(52) U.S. Cl. CPC G06Q 10/06316
USPC 705/7.26

(57) ABSTRACT

Embodiments of the invention provide a method, system and computer program product for automating customer relationship management (CRM) tasks responsive to inbound and outbound messages. In an embodiment of the invention, a method of automating CRM tasks responsive to inbound and outbound messages is provided. The method includes determining a context for a message such as an e-mail, monitoring a set of manual operations performed by an end user in a CRM application subsequent to the determination of the context of the message, grouping the set of manual operations into an automated task for the CRM application, and storing a rule associating the automated task with the context. Thereafter, in response to detecting receipt of a new message, a context is matched for the new message to the rule and the automated task associated with the rule is triggered.

### BACKGROUND OF THE INVENTION

1. Field of the Invention

The present invention relates to task automation and more particularly to task automation in a CRM application.

2. Description of the Related Art

Task automation refers to the automated performance of different operations in order to achieve a task. Originally akin to “macro” processing, task automation involved the end user specifying a selection of operations or keystrokes in an application and storing the selection as a macro. Thereafter, the activation of the macro resulted in the automated execution of the selected operations or keystrokes as if those selected operations or keystrokes were input manually in sequence by an end user. Subsequent advancements in task automation have resulted in separate applications able to access both the event queue for an operating system and also the application programming interface (API) of a co-existing application in the operating system. As such, one or more operations present in the API of the co-existing application can be triggered in response to the detection of an event in the event queue of the operating system.

Task automation finds particular application in the field of electronic communications and specifically e-mail communications. In a modern e-mail client, the end user is able not only to set automated tasks resulting from the receipt of an e-mail message, but the end user is able to do so both on the client side and also the server side so that the automated tasks are triggered irrespective of the particular e-mail client used to access the e-mail server. The tasks available for automation include primarily the manipulation of the received e-mail message triggering the automated task or tasks, including the forwarding or creating of a new e-mail message. Further, the automated tasks can be triggered not only based upon the source of the e-mail message, but also based upon the context of the received e-mail message such as terms contained in any field of the e-mail message or the time of day or day of the week when the e-mail message is received.

Regrettably, the high degree of task automation available in the context of an e-mail management system is largely limited to the context of e-mail management. Yet, actions that are often manually performed in consequence of the receipt of an e-mail message are not related to the management of the received e-mail message. In particular, in a CRM application environment, tedious manual tasks are often performed in consequence of the receipt of an e-mail message including creating new contacts in a contact management portion of the CRM application, or linking incoming e-mail messages to non-e-mail records in the CRM application.

### BRIEF SUMMARY OF THE INVENTION

Embodiments of the present invention address deficiencies of the art in respect to automated task management and provide a novel and non-obvious method, system and computer program product for automating CRM tasks responsive to inbound and outbound messages. In an embodiment of the invention, a method of automating CRM tasks responsive to inbound and outbound messages is provided. The method includes determining a context for a message such as an e-mail, monitoring a set of manual operations performed by an end user in a CRM application subsequent to the determination of the context of the message, grouping the set of manual operations into an automated task for the CRM application, and storing a rule associating the automated task with the context. Thereafter, in response to detecting receipt of a new message, a context is matched for the new message to the rule and the automated task associated with the rule is triggered.

In another embodiment of the invention, a CRM data processing system is configured to automate CRM tasks responsive to inbound and outbound messages. The system includes a host computing system that has at least one computer with at least one processor and memory, an e-mail server executing in the memory of the host computing system along with a CRM application. The system yet further includes a CRM task automation module coupled to the CRM application. The module includes computer program code enabled upon execution in the memory of the host computing system to determine a context for an e-mail received in the e-mail server, to monitor a set of manual operations performed through the CRM client subsequent to the receipt of the e-mail, to group the set of manual operations into an automated task for the CRM application, to store a rule associating the automated task with the context, and to respond to detecting receipt of a new e-mail by matching a context for the new e-mail to the rule and triggering the automated task associated with the rule.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for automating CRM tasks responsive to inbound and outbound messages;

FIG. 2 is a schematic illustration of a CRM data processing system configured for automating CRM tasks responsive to inbound and outbound messages; and,

FIG. 3 is a flow chart illustrating a process for automating CRM tasks responsive to inbound and outbound messages.

### DETAILED DESCRIPTION OF THE INVENTION

Embodiments of the invention provide for automating CRM tasks responsive to inbound and outbound messages. In an embodiment of the invention, an e-mail message can be received and, in response to the receipt of the e-mail message manual tasks in the CRM application can be monitored. For example, the linking of the e-mail message to a particular record in the CRM application can be observed. Thereafter, a prompt can be generated for display in the CRM application to create an automated task of the manual tasks to be triggered based upon a context of the received e-mail message. Finally, a rule can be created linking the automated task and the context of the e-mail message so that a subsequent receipt of an e-mail message with a matching context will trigger the automated task in the CRM application.

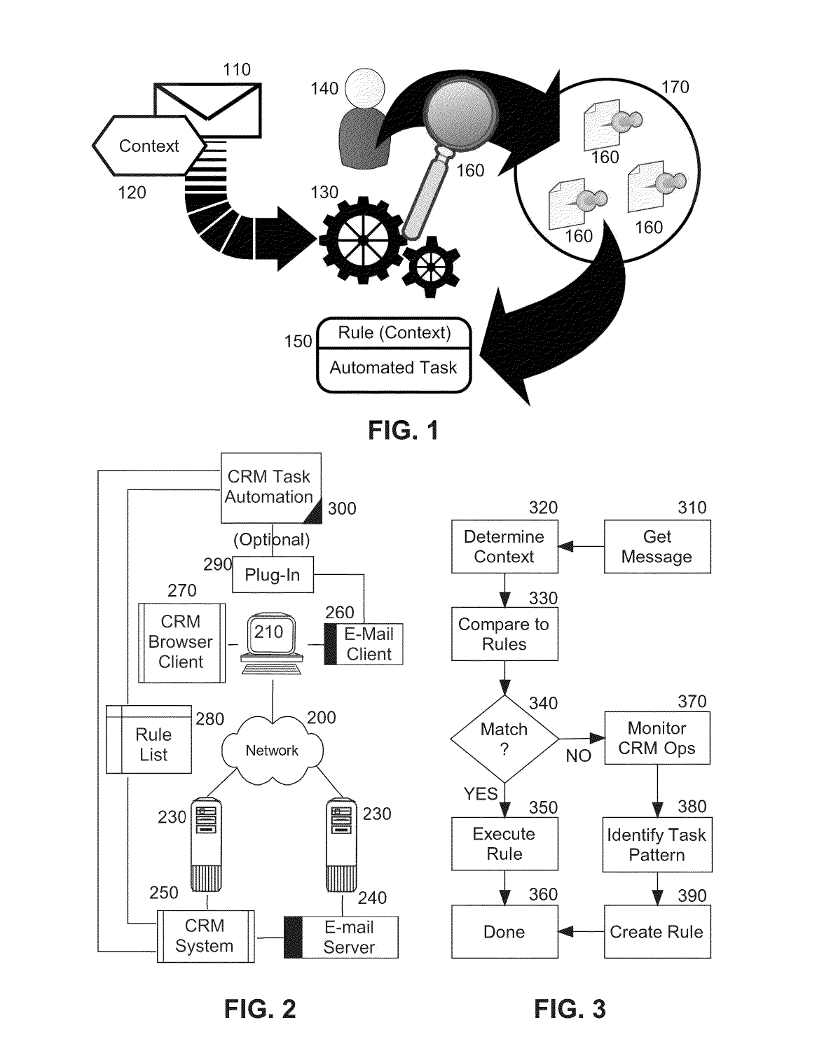

In further illustration, FIG. 1 is a pictorial illustration of a process for automating CRM tasks responsive to inbound and outbound messages. As shown in FIG. 1, a message 110 can be received for instance an e-mail message, text message or instant message. A context for the message 110 can be determined, such as the sender, recipient or recipients, time of day or day of week of transmission, a subject, a term in the subject, a term derived from other terms in the subject or the body of the message, an assigned priority, or a term in the body of the message. Thereafter, monitor 160 of task automation logic 130 can monitor the manual operations 160 performed by an end user 140 in a CRM application including a messaging component of the CRM application. The manual operations 160 can include, by way of example, associating the message with a database record in the CRM application, or archiving the message in storage of the CRM application in association with a specific contact of the CRM application as a CRM record of the CRM application, or performing any other task in CRM application, for example, creating a new support case in the CRM application.

A selection or sequence of the manual operations 160 can be grouped together into an automated task 170. The automated task 170 in turn can be configured for triggering in the CRM application within a rule 150 associating the automated task 170 with the context 120. As a consequence, when a subsequent message is received, a context 120 can be determined for the subsequent message and if the context matches the rule 150, the associated automated task 170 can be performed automatically.

The process of FIG. 1 can be implemented within a CRM data processing system. In yet further illustration, FIG. 2 schematically shows a CRM data processing system configured for automating CRM tasks responsive to inbound and outbound messages. The system can include a client computer 210 configured for communicative coupling to a host computing system 230 over computer communications network 200. The host computing system 230 can include one or more servers, each with at least one processor and memory supporting the operation, respectively, of an e-mail server 240 and a CRM system 250.

The client computer 210 also can include at least one processor and memory and can support the operation of both an e-mail client 260 communicating with the e-mail server 240, and also a CRM client 270 for instance a browser based interface to the CRM system 250, communicating with the CRM system 250. In this regard, the e-mail client 260 can be configured to retrieve e-mail messages from the e-mail server 240 and to compose and transmit e-mail messages through the e-mail server 240. Likewise, the CRM client 270 can be configured to display and manage a user interface to the CRM system 250 through which end user operations in the CRM system 250 can be directed by an end user.

Of note, a CRM task automation module 300 can be coupled to the CRM system 250. Optionally, the CRM task automation module 300 can be coupled to a plug-in 290 to the e-mail client 260. The CRM task automation module 300 can include program code that when executed in the memory of the host computing system 230, is enabled to determine a context for a received e-mail message in the e-mail server 240, monitor subsequent user performed operations in the CRM system 250, create an automated task of the operations, and map the automated task to the determined context in a rule within a rule list 280. Later, the program code of the CRM task automation module 300 can be enabled to execute the automated task when an e-mail message is received in the e-mail server 240 of a determined context for the rule in the rule list 280.

In even yet further illustration of the operation of the CRM task automation module 300, FIG. 3 is a flow chart illustrating a process for automating CRM tasks responsive to inbound messages. Beginning in block 310, a message can be received and in block 320, a context for the message can be determined. In block 330 the context can be compared to a set of rules in a rule list. In decision block 340, if a rule matches the context, in block 350, the automated task associated with the matching rule can be triggered. Thereafter, in block 360 the process can end.

In decision block 340, however, if a rule in the rule list does not match the context, in block 370 operations performed in an associated CRM system can be monitored and in block 380, a pattern of operations performed by the end user can be identified. In block 390, a rule can be created associating the pattern of operations with the context. Subsequently, the process can end in block 360. In this way, even in the absence of the execution of the e-mail client, the CRM task automation module 300 coupled to the CRM application can monitor e-mail messages in a remote e-mail server and upon receipt of a message with a context matching one of the rules in the rule list, a corresponding set of operations in an automated task can be executed automatically thereby relieving the end user from manually performing each operation in the automated task or even requiring the end user to maintain an executing instance of the a CRM client in a client computer.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method of automating customer relationship management (CRM) tasks responsive to inbound and outbound messages, the method comprising:
determining a context for a message;
monitoring a set of manual operations performed by an end user in a CRM application subsequent to the determination of the context of the message;
grouping the set of manual operations into an automated task for the CRM application;
storing a rule associating the automated task with the context; and,
responsive to detecting receipt of a new message, matching a context for the new message to the rule and triggering the automated task associated with the rule.

2. The method of claim 1, wherein the message is an e-mail message.

3. The method of claim 1, wherein the manual operations include linking the message to a record in the CRM application.

4. The method of claim 1, wherein the manual operations include archiving the message in association with a record of the CRM application.

5. The method of claim 1, wherein the context includes a sender of the message.

6. The method of claim 1, wherein the context includes a term disposed within a body of the message.

7. A customer relationship management (CRM) data processing system configured to automate CRM tasks responsive to inbound and outbound messages, the system comprising:
a host computing system comprising at least one computer with memory and least one processor and memory;
an e-mail server executing in the memory of the host computing system along with a CRM application; and,
a CRM task automation module coupled to the CRM application, the module comprising computer program code enabled upon execution in the memory of the host computing system to determine a context for an e-mail received in the e-mail server, to monitor a set of manual operations performed in the CRM application subsequent to the receipt of the e-mail, to group the set of manual operations into an automated task for the CRM application, to store a rule associating the automated task with the context, and to respond to detecting receipt of a new e-mail by matching a context for the new e-mail to the rule and triggering the automated task associated with the rule.

8. The system of claim 7, wherein the manual operations include linking the e-mail to a record in the CRM application.

9. The system of claim 7, wherein the manual operations include archiving in storage the e-mail in association with a contact record of the CRM application.

10. The system of claim 7, wherein the context includes a sender of the e-mail.

11. The system of claim 7, wherein the context includes a term disposed within a body of the e-mail.

12. A computer program product for automating customer relationship management (CRM) tasks responsive to inbound and outbound messages, the computer program product comprising:
a computer readable storage medium having computer readable program code embodied therewith, the computer readable program code comprising:
computer readable program code for determining a context for a message;
computer readable program code for monitoring a set of manual operations performed by an end user in a CRM application subsequent to the determination of the context of the message;
computer readable program code for grouping the set of manual operations into an automated task for the CRM application;
computer readable program code for storing a rule associating the automated task with the context; and,
computer readable program code for responding to detecting receipt of a new message by matching a context for the new message to the rule and triggering the automated task associated with the rule.

13. The computer program product of claim 12, wherein the message is an e-mail message.

14. The computer program product of claim 12, wherein the manual operations include linking the message to a record in the CRM application.

15. The computer program product of claim 12, wherein the manual operations include archiving in storage the message in association with a contact record of the CRM application.

16. The computer program product of claim 12, wherein the context includes a sender of the message.

17. The computer program product of claim 12, wherein the context includes a term disposed within a body of the message.
